(19) United States
(12) Patent Application Publication
(10) Pub. No.: US 2025/0189000 A1
(43) Pub. Date: Jun. 12, 2025

(54) DISC BRAKE SYSTEM WITH TORQUE PLATE, TORQUE PLATE AND METHODS FOR THE USE AND ASSEMBLY THEREOF

(71) Applicant: Bendix Commercial Vehicle Systems LLC, Avon, OH (US)

(72) Inventors: Alan Backstrom, Madison, TN (US); Erik W. Oberdorfer, Akron, OH (US)

(73) Assignee: Bendix Commercial Vehicle Systems LLC, Avon, OH (US)

(21) Appl. No.: 18/532,702

(22) Filed: Dec. 7, 2023

(51) Int. Cl. F16D 65/095; B60T 1/06; F16D 55/00; F16D 55/225; F16D 65/00; F16D 65/097

(52) U.S. Cl. CPC F16D 65/095; B60T 1/065; F16D 55/225; F16D 65/0056; F16D 65/0068; F16D 65/0974; F16D 2055/0008; F16D 2055/0016

(57) ABSTRACT

A disc brake system includes a torque plate having a mounting portion with an opening shaped to receive a vehicle axle and a carrier portion integrally formed with the mounting portion as a one-piece unit. The carrier portion includes an inboard leading pad support, an inboard trailing pad support, an outboard leading pad support, and an outboard trailing pad support. One or both of an inboard and/or outboard brake pad include a bearing surface engaged by a bearing surface on one of the pad supports when the disc brake system is actuated such that at least a portion of the at least one inboard and/or outboard brake pads is put in tension. At least one of the pad supports may include a slot defining the bearing surface. Methods of actuating and assembling the disc brake system are also disclosed.

### FIELD OF THE INVENTION

The present application relates generally to a disc brake system, and in particular to a disc brake system including an torque plate having integral mounting and carrier portions, together with methods for the use and assembly thereof.

### BACKGROUND

Disc brake systems may be configured with opposing pairs of brake pads that engage a rotor to slow and/or stop a vehicle. In operation, a moment is created between a brake pad drag force and an abutment force, which may lead to a greater amount of pressure being applied to the leading edge of the brake pad during braking. This uneven pressure distribution may lead to tapered pad wear, where the leading end of the brake pad friction material wears away faster than the trailing end. As such, the brake pads do not wear evenly and may need to be replaced more frequently.

The loads applied to the brake pads are typically absorbed by a carrier mechanically coupled to a torque plate. The assembly of the carrier and torque plate requires installation of various fasteners, and may adversely affect the positioning of the caliper and/or brake pads. The carrier and torque plate may include wide platforms to accommodate the fasteners, or require lateral clearance for the fasteners. Moreover, the carrier is configured with an outboard beam, which is necessary to locate and stabilize carrier horns, which prevents any deflection thereof. The increased weight of the carrier and torque plate, and requisite fasteners, increases the overall cost of the system and the associated assembly times.

### SUMMARY

The present invention is defined by the following claims, and nothing in this section should be considered to be a limitation on those claims.

In one aspect, one embodiment of a disc brake system includes a torque plate having a mounting portion with an opening shaped to receive a vehicle axle and a carrier portion integrally formed with the mounting portion as a one-piece unit. The carrier portion includes an inboard leading pad support, an inboard trailing pad support, an outboard leading pad support, and an outboard trailing pad support. The inboard leading and trailing pad supports are spaced apart and define an inboard pad receiving opening, and the outboard leading and trailing pad supports are spaced apart and define an outboard pad receiving opening. At least one of the inboard and/or outboard leading pad supports includes a first bearing surface facing away from a corresponding one of the inboard and/or outboard receiving openings. An inboard brake pad is disposed in the inboard pad receiving opening and an outboard brake pad is disposed in the outboard pad receiving opening. At least one of the inboard and/or outboard brake pads includes a second bearing surface facing toward the first bearing surface on the carrier pad supports and the corresponding one of the inboard and/or outboard receiving openings. The first and second bearing surfaces are configured to engage when the disc brake system is actuated such that at least a portion of the at least one inboard and/or outboard brake pads is put in tension.

In another aspect, one embodiment of a torque plate for a disc brake system includes a mounting portion with an opening shaped to receive a vehicle axle and a carrier portion integrally formed with the mounting portion as a one-piece unit. The carrier portion includes an inboard leading pad support, an inboard trailing pad support, an outboard leading pad support, and an outboard trailing pad support. The inboard leading and trailing pad supports are spaced apart and define an inboard pad receiving opening, and the outboard leading and trailing pad supports are spaced apart and define an outboard pad receiving opening. At least one of the inboard and/or outboard leading pad supports includes a slot defining a bearing surface facing away from a corresponding one of the inboard and/or outboard receiving openings.

In another aspect, one embodiment of a method of actuating a disc brake system includes engaging a rotor rotating about an axis with inboard and outboard brake pads, applying a tension force to a leading end of at least one of the inboard and/or outboard brake pads in response to the engaging of the rotor, and absorbing the tension force with a carrier portion of a torque plate. The carrier portion is integrally formed with a mounting portion as a one-piece unit, wherein the mounting portion has an opening centered about the axis and shaped to receive a vehicle axle.

Various other methods of using and assembling the disc brake system are also provided.

The various embodiments of the disc brake system and components, and methods for the use and assembly thereof, provide significant advantages over other disc brake systems and methods. For example, and without limitation, the interface between the brake pad(s) and carrier portions acting in tension reduces the likelihood of tapered pad wear, such that the brake pads wear more evenly and do not need to be replaced as frequently. In addition, the integral formation of the carrier portion and the mounting portion as a single piece torque plate unit improves the stability and strength of the torque plate, while simplifying the system, reducing the assembly time and eliminating various fasteners, which may be lost and/or improperly installed. The system also avoids a junction between the two components that may be susceptible to corrosion. The integral torque plate also provides a stable machining geometry for the pad supports and corresponding pad clearance, which minimizes the risk of pad kick. The improved one-piece torque plate also reduces or eliminates joint slip during dynamic loading of the torque plate.

The foregoing paragraphs have been provided by way of general introduction, and are not intended to limit the scope of the claims presented below. The various preferred embodiments, together with further advantages, will be best understood by reference to the following detailed description taken in conjunction with the accompanying drawings.

### BRIEF DESCRIPTION OF THE DRAWINGS

FIG. 1 is a perspective view of one embodiment of a disc brake system.

FIG. 2 is an outboard side view of the disc brake system shown in FIG. 1.

FIG. 3 is a top view of the disc brake system shown in FIG. 1.

FIG. 4 is an outboard side view of an alternative embodiment of the disc brake system.

FIG. 5 is a perspective view of one embodiment of an torque plate.

FIG. 6 is an inboard view of the torque plate shown in FIG. 5.

FIG. 7 is an outboard view of the torque plate shown in FIG. 5.

FIG. 8 is a perspective view of another embodiment of an torque plate.

FIG. 9 is an inboard view of the torque plate shown in FIG. 8.

FIG. 10 is an outboard view of the torque plate shown in FIG. 8.

FIG. 11 is a perspective view of another embodiment of an torque plate.

FIG. 12 is an inboard view of the torque plate shown in FIG. 11.

FIG. 13A is an outboard view of one embodiment of the torque plate shown in FIG. 11.

FIG. 13B is an outboard view of another embodiment of the torque plate shown in FIG. 11.

FIG. 13C is a partial, enlarged view of a brake pad and carrier portion interface.

FIG. 14 is a perspective view of another embodiment of an torque plate.

FIG. 15 is an inboard view of the torque plate shown in FIG. 14.

FIG. 16 is an outboard view of the torque plate shown in FIG. 14.

FIG. 17 is a perspective view of another embodiment of an torque plate.

FIG. 18 is an inboard view of the torque plate shown in FIG. 17.

FIG. 19 is an outboard view of the torque plate shown in FIG. 17.

FIG. 20 is a top view of the disc brake system configured one of the torque plates shown in FIG. 11 or 17.

FIG. 21 is an exploded view of one embodiment of an air disc brake system.

FIG. 22 is schematic diagram showing the load path in a brake pad.

FIG. 23A is a schematic representation of the load transfer from a brake pad to a torque plate during a low torque braking operation.

FIG. 23B is a schematic representation of the load transfer from a brake pad to a torque plate during a high torque braking operation.

FIG. 24 is a cross sectional view of an air disc brake system.

### DETAILED DESCRIPTION OF THE PRESENTLY PREFERRED EMBODIMENTS

It should be understood that the term “plurality,” as used herein, means two or more. The term “longitudinal,” as used herein means of or relating to a length or lengthwise direction 2, or X direction, for example a direction running parallel to a brake pad. The term “lateral,” as used herein, means situated on, directed toward or running in a side-to-side direction 4, or Y direction, transverse to the longitudinal direction 2. The term “transverse” means non-parallel. The term “outboard” refers to a position or a direction facing outwardly away from a centralized location, for example a rotor 128, while the term “inboard” refers to a position or a direction facing inwardly relative to the rotor 128.

The term “coupled” means connected to or engaged with, whether directly or indirectly, for example with an intervening member, and does not require the engagement to be fixed or permanent, although it may be fixed or permanent. The terms “first,” “second,” and so on, as used herein are not meant to be assigned to a particular component so designated, but rather are simply referring to such components in the numerical order as addressed, meaning that a component designated as “first” may later be a “second” such component, depending on the order in which it is referred. It should also be understood that designation of “first” and “second” does not necessarily mean that the two components or values so designated are different, meaning for example a first direction may be the same as a second direction, with each simply being applicable to different components.

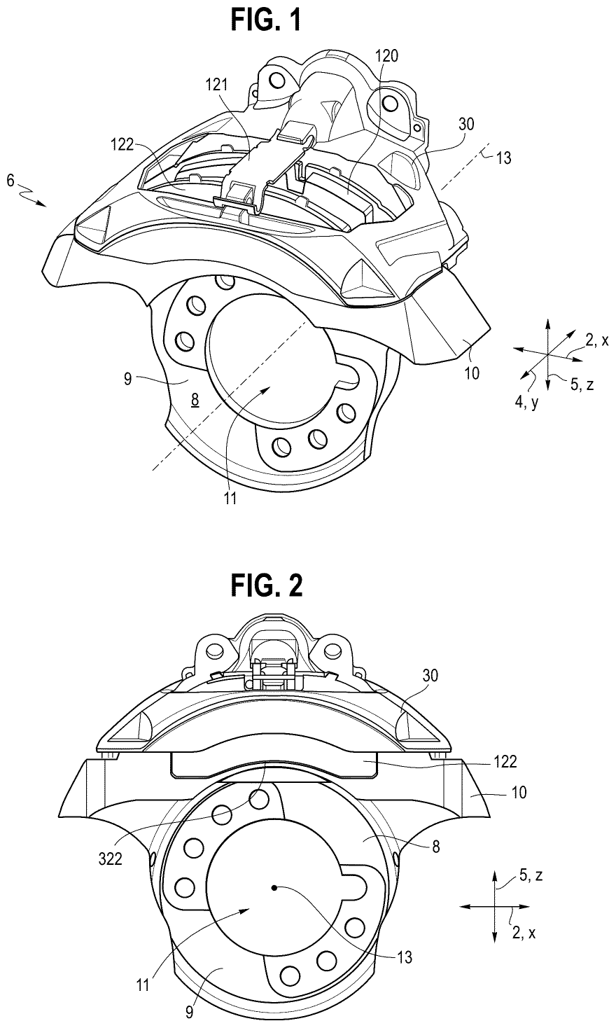

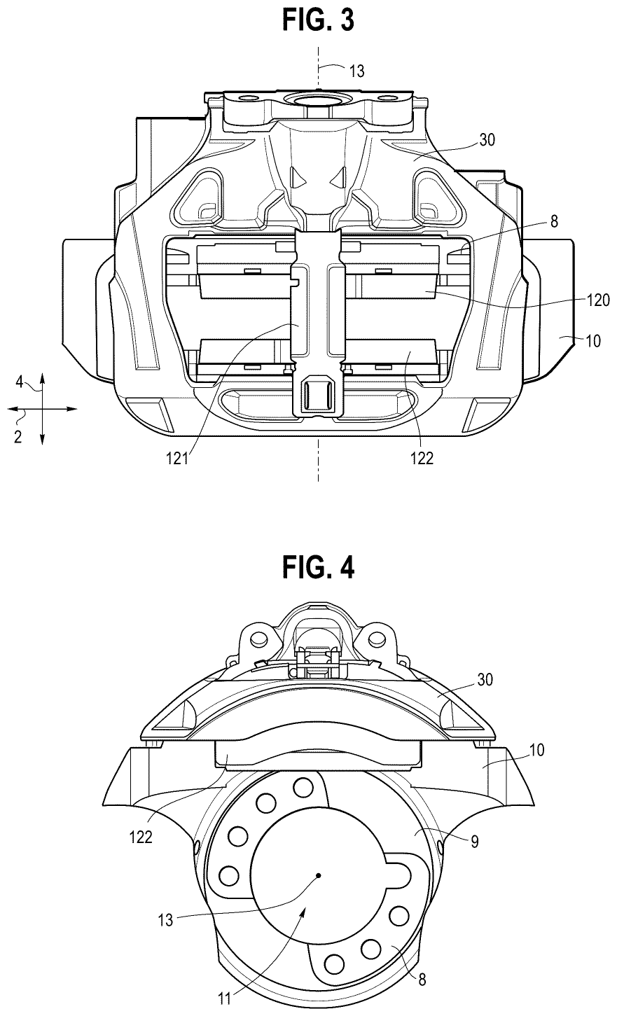

Referring to FIGS. 1-3, 5, 8, 11,14, 20 and 21, a disc brake system 6 includes a torque plate 8 having a mounting portion 9 and a carrier portion 10, with the carrier portion 10 being integrally formed with the mounting portion 9 as a single piece or unit. The phrase “integrally formed” refers to the torque plate 8 being homogenous, with the mounting portion 9 and carrier portion 10 being shaped during the same forming operation, for example die casting and/or machining, and wherein the pieces are not otherwise joined together by mechanical or other fastening systems including welding. The mounting portion 9 has an opening 11 shaped to receive a vehicle axle and defining an axis 13 extending in the lateral direction 4. The carrier portion 10 has an inboard leading pad support 302, an inboard trailing pad support 304, an outboard leading pad support 306, and an outboard trailing pad support 308. It should be understood that the terms “leading” and “trailing” refer to the orientation of various components, such as the pad supports, on the torque plate 8, and corresponding brake system 6, when installed on one side of the vehicle, and that the brake system 6 and torque plate 8 may be installed on the opposite side of the vehicle, with the “leading” and “trailing” components being reversed. As such, a leading pad support 302 on one side of the vehicle may be a trailing pad support on the other side, and vice versa.

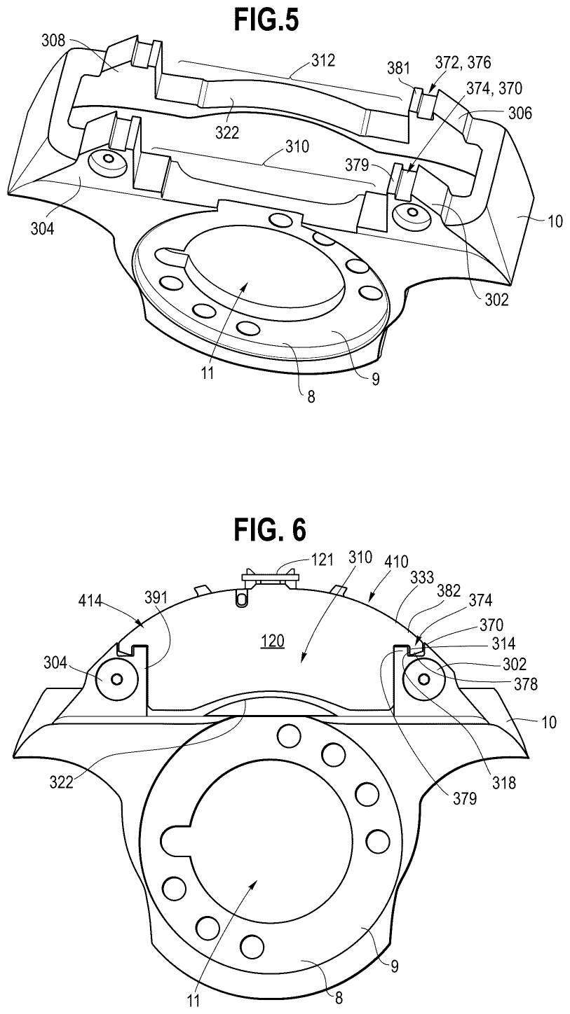

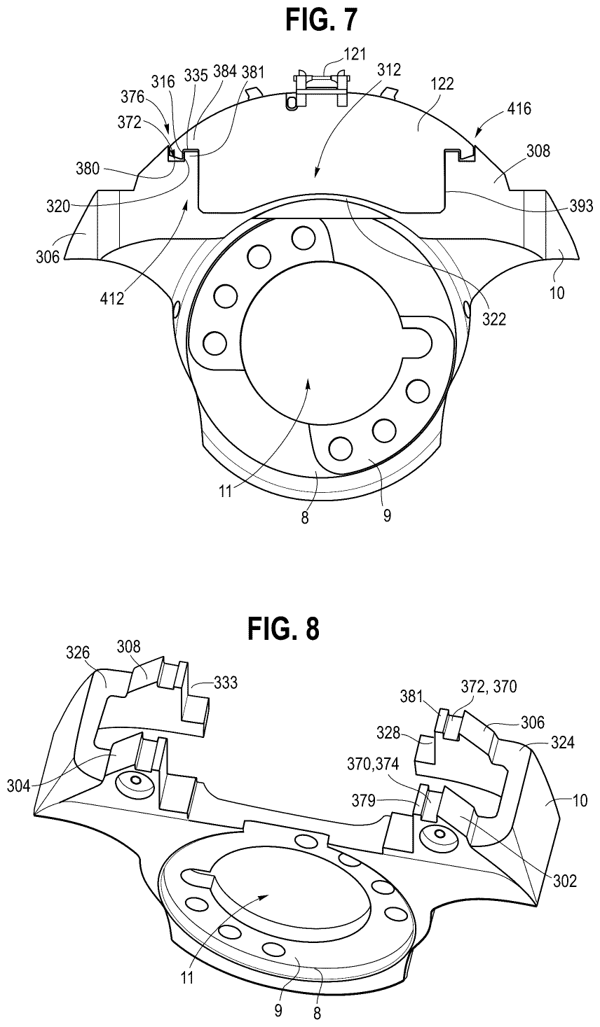

The pad supports 302, 304, 306, 308 may be referred to as horns, in that then extend outwardly from the opening 11 of the mounting portion, for example in a Z-direction 5. It should be understood that the X direction is not necessarily horizontal, or the Z direction vertical, but rather that those directions are orthogonal and may rotate about the Y axis depending on the location of the disc brake system, which may be positioned at any orientation about the Y axis. The inboard leading and trailing pad supports 302, 304, or horns, are spaced apart in the longitudinal direction 2 and define an inboard pad receiving opening 310, while the outboard leading and trailing pad supports 306, 308 are spaced apart in the longitudinal direction 2 and define an outboard pad receiving opening 312. As shown in FIGS. 5-7, for example and without limitation, the inboard and/or outboard leading pad supports 302, 306 may each include a bearing surface 314, 316, or abutment surface, facing away from a corresponding one of the inboard and/or outboard receiving openings 310, 312.

An inboard brake pad 120 is disposed in the inboard pad receiving opening 310 and an outboard brake pad 122 is disposed in the outboard pad receiving opening 312. The inboard and outboard brake pads 120, 122 include a bearing surface 318, 320 facing toward the bearing surface 314, 316 respectively and the corresponding one of the inboard and/or outboard receiving openings 310, 312. The first and second bearing surfaces 314, 318 of the inboard pad support 302 and brake pad 120 and/or the first and second bearing surfaces 316, 320 of the outboard pad support 306 and brake pad 122, are configured to engage when the disc brake system is actuated such that at least a portion of the at least one inboard and/or outboard brake pads 120, 122, and in particular the leading ends thereof, is/are put in tension. It should be understood that both, or only one, of the inboard and outboard brake pads and pad support combinations may include bearing surfaces.

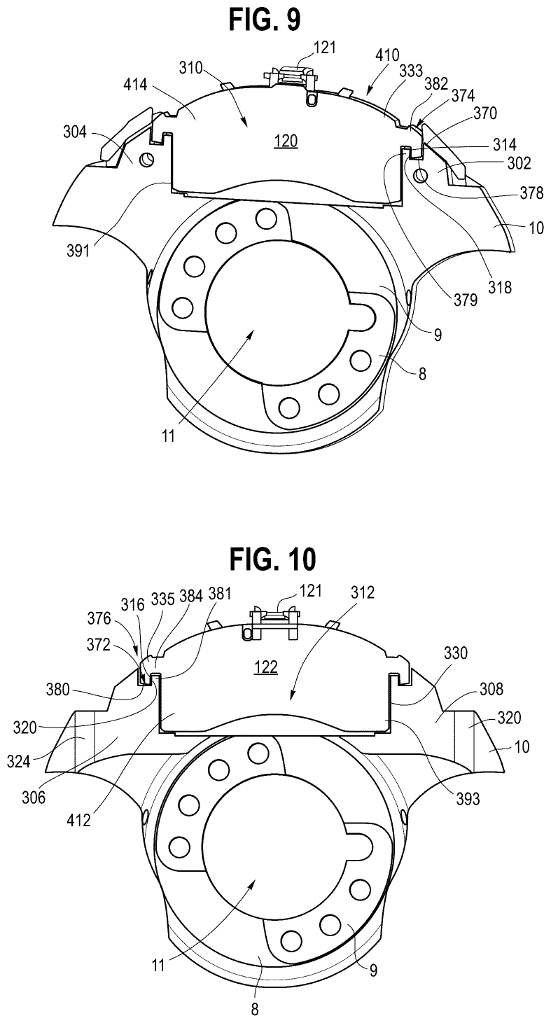

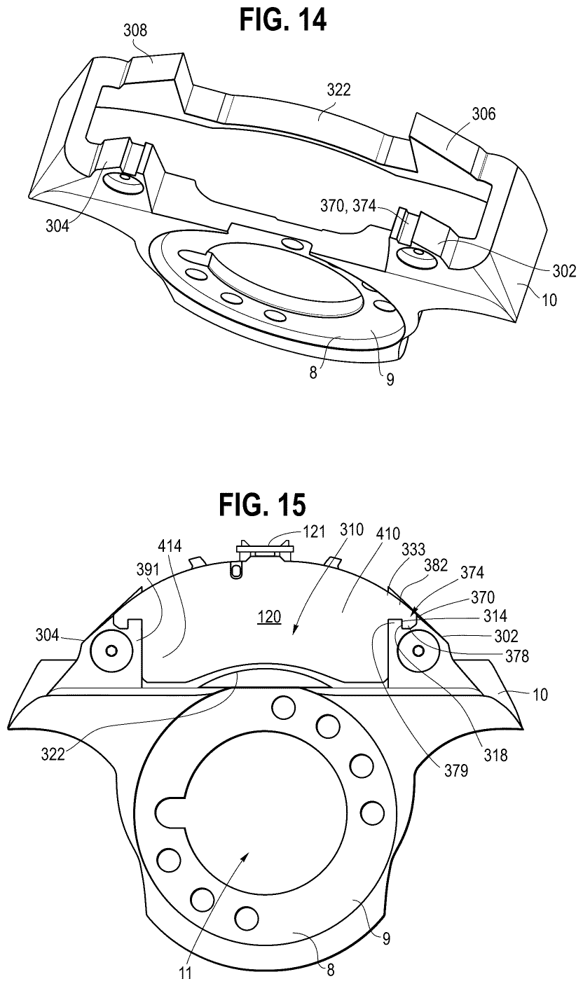

In one embodiment, the inboard leading and trailing pad supports 302, 304 are aligned with the mounting portion 9 as shown in FIG. 5, or lie substantially in the same XZ plane, while the outboard leading and trailing pad portions 306, 308 are laterally spaced from the mounting portion 9 in the lateral Y direction 4. In the embodiments of FIGS. 5-7 and 14-16, the torque plate 8 includes a beam 322 extending between and connecting the outboard leading and trailing pad supports 306, 308. In the embodiments of FIGS. 8-13C and 17-19, the outboard leading and trailing pad supports 306, 308 are cantilevered, meaning the pad supports are fixed only at one end 324, 326, and have a free end 328, 331 defining the pad receiving opening 312.

Referring to the embodiment of FIGS. 5-7, both the outboard and inboard leading pad supports 302, 306 define a bearing surface 314, 316, or abutment surface, that may be engaged by corresponding bearing surfaces 318, 320, or abutment surfaces, on leading ends 333, 335 of the outboard and inboard brake pads 120, 122. The leading ends 333, 335 are longitudinally spaced in the longitudinal X direction 2 from trailing ends 416, 414 of the outboard and inboard brake pads 120, 122.

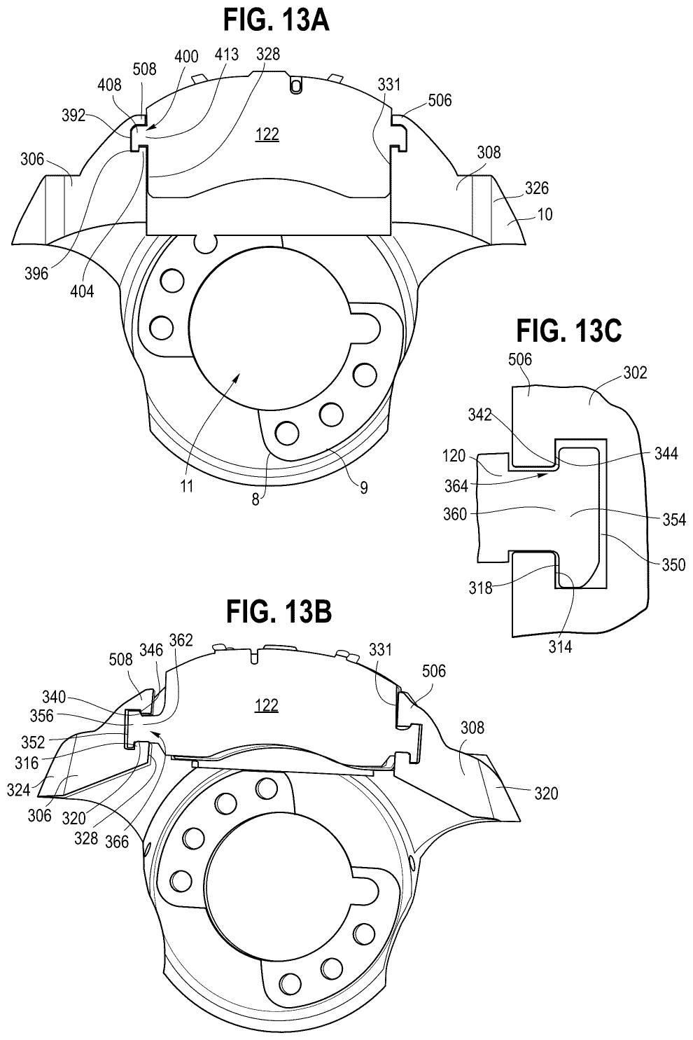

In one embodiment, shown in FIG. 13B, the outboard leading pad support 306 includes a pair of spaced apart first bearing surfaces 316, 340 facing away from the inboard pad receiving opening 312. It should be understood that that the inboard leading pad support 302 may also be configured with a pair of spaced apart bearing surfaces 314, 344 as shown in FIG. 13C. Likewise, each of the inboard and/or outboard brake pads 120, 122 includes a pair of spaced apart second bearing surfaces 320, 346, 318, 342 facing toward the first bearing surfaces 314, 344, 316, 340 and the corresponding one of the inboard and/or outboard receiving openings 310, 312 wherein the pairs of first and second bearing surfaces are configured to engage when the disc brake system is actuated. In one embodiment, the inboard and/or outboard leading pad supports 302, 306 are configured with a T-shaped opening 350, 352 defining the pair of spaced apart first bearing surfaces 314, 344, 316, 340. Correspondingly, the inboard and/or outboard brake pads 120, 122 each have a hammerhead (T-shaped) end portion 354, 356 defining the pair of spaced apart second bearing surfaces 320, 346, 318, 342, wherein the hammerhead end portion 354, 356 is disposed in a corresponding one of the T-shaped openings 350, 352. The hammerhead end portions 354, 356 each have a neck portion 360, 362 that extends through a mouth 364, 366 of the T-shaped opening, with the neck portion 360, 362 being put in tension during braking as described further herein below. In various embodiments the end portions 354, 356 and the openings 350, 352 have complimentary shapes, which may be configured other than as a T-shape or hammerhead shape, but with mating abutment surfaces.

In the embodiment of FIGS. 5-10, the pad supports 302, 306 are configured with a slot 370, 372 having a mouth 374, 376 opening outwardly in the Z direction 5 at a location spaced from the pad receiving openings 310, 312, such that a support wall 379, 381 is formed and defines the bearing surface 314, 316. The pads 120, 122 each include a tab 378, 380 that may be inserted into the slot 370, 372, with a neck 382, 384 connecting the tab 378, 380 to the pad being put in tension and bending during actuation of the brake system.

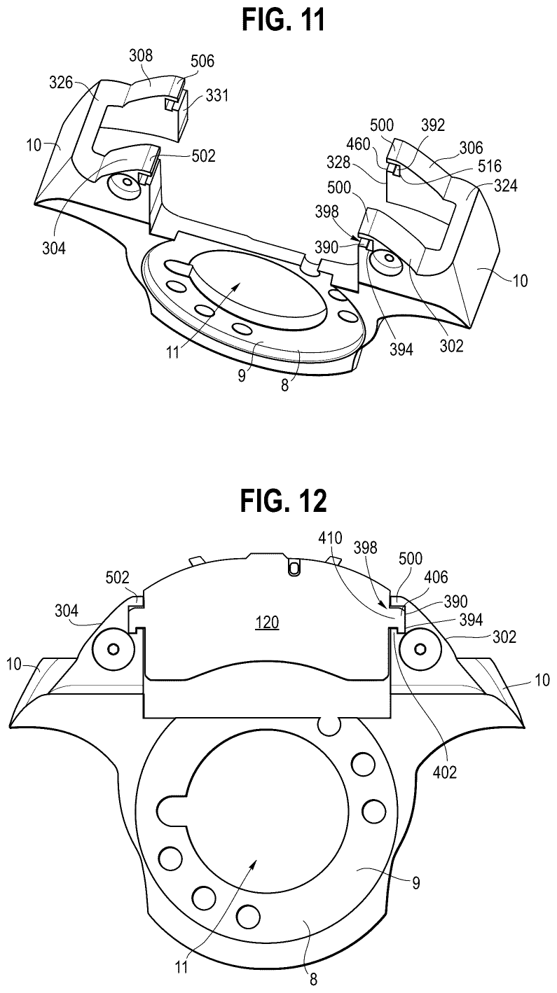

In the embodiment of FIGS. 11-13A, the pad supports 302, 306 are configured with an opening 390, 392 having an L-shape or elbow shape, with a slot 394, 396 and a mouth 398, 400 communicating between the slot 394, 396 and the pad receiving opening 310, 312. A support wall 402, 404 is formed in and defined by the slot 394, 396, with the support wall further defining the bearing surface 314, 316. The pads 120, 122 each include a tab 406, 408 (e.g., L-shaped or elbow shaped) that may be inserted into the slot, with a neck 411, 413 disposed in the mouth 398, 400 and connecting the tab to the pad being put in tension and bending during actuation of the brake system.

In various embodiments, either and/or both of the inboard and outboard leading pad supports 302, 306 may include a first bearing surface, and either and/or both of the inboard and outboard brake pads 120, 122 may include the second bearing surface engaging the first bearing surface. In other embodiments, each of the inboard leading pad support 302, the inboard trailing pad support 304, the outboard leading pad support 306, and the outboard trailing pad support 308 are configured with a slot, whether T-shaped, elbow shaped or opening outwardly along the Z axis, and wherein each of the inboard and outboard brake pads 120, 122 is configured with opposite ends having tabs disposed in corresponding ones of the slots.

The inboard and outboard brake pads 120, 122 each include a backing plate 330, 332 and a friction material 334, 336 supported by the backing plate. The bearing surfaces 318, 320, 342, tabs 378, 380, 406, 408 and end portions 354, 356 are formed on the backing plate 330, 332, which is made of a material suitable to absorb the tension and/or bending loads applied thereto, such as metal, including for example and without limitation a stamped steel or cast iron.

In operation, and referring to FIGS. 23-23B, the method of actuating the disc brake system includes engaging the rotor 128 rotating about the axis 13 with inboard and outboard brake pads 120, 122. As the rotor 128 is engaged by the pads 120, 122, a friction force Fbrake is applied to the friction material 334, 336 in a tangential direction relative to the pad and brake disc contact path. This produces a force in the direction of sliding and a moment about the center of contact pressure. The moment is generated by the forces on the leading side of the pad including an outwardly directed radial force component while the trailing side of the pad experiences an inwardly directed radial force component, resulting in a moment about the center of pressure. At the same time, a force Ft is applied normal to the pad backplate in the Y direction by one or more tappets 124. Considering the sum of forces in the Y-direction reveals Ft=Fr+Fhy, where Fr is the reaction force applied by the rotor 128. The backing plate 330, 332 absorbs a frictional force Fhx by relative sliding between the carrier portion 10 and the backing plate 330, 332. The braking forces coupled with the pad geometry create a moment (M1) about the radial axis local to the center of pressure between the pad and brake disc contact area, with M1=Fbrake×D1. M1 superimposed over Fr produces an uneven pressure distribution in the direction of sliding resulting in uneven friction material wear known as taper wear. In a conventional braking plate design, wherein the brake pad is not put in tension, a frictional force between the trailing end of the backplate and the carrier may produce a moment (M3) that further increases the uneven pressure distribution. Therefore, the total moment promoting friction material taper wear equals M1+M3. The disclosed embodiments of the brake pad counteract M1 and M3 via at least two design functions. First, the backing plate contact is shifted from the trailing end to the leading end of the backing plate thus eliminating M3. Second, a moment (M2) is generated by Fhy×D2 acting in the opposite direction of M1 therefore counterbalancing the moments that cause friction material taper wear.

As shown in FIG. 23A, during low torque applications, the friction load (Fbrake) applied to the outboard pad 122 may be carried entirely by the bearing surfaces 318, 342, which puts the neck portion 360 in tension in response to a load of 2T1. If only one bearing surface is presented, then the neck portion 318 may experience tension and bending. The opposite end 391, 393 of the pads 120, 122 may not experience contact during low torque applications due to clearance G, thus loading only the leading end abutment of bearing surfaces 318, 342. The load T1 increases directly proportional to braking force (Fbrake) thus increasing deflection of the torque plate abutment surfaces 318, 342 and therefore reducing clearance G. This function produces a design mechanism to share braking forces across the leading and trailing abutments during high braking torques as the clearance G is closed, or becomes zero. This load sharing feature lowers peak bending moments, thereby resulting in material reducing opportunities and component mass optimization. The closing of the gap G, and compression applied by the carrier pad support 304, 308, may be experienced especially when the carrier pad supports 303, 304, 306, 308 are cantilevered. In other embodiments, the brake pad experiences both compression and tension, or only tension. For example, in a high torque application, the load applied to the outboard brake pad is 2T2+2C2, as shown in FIG. 23B.

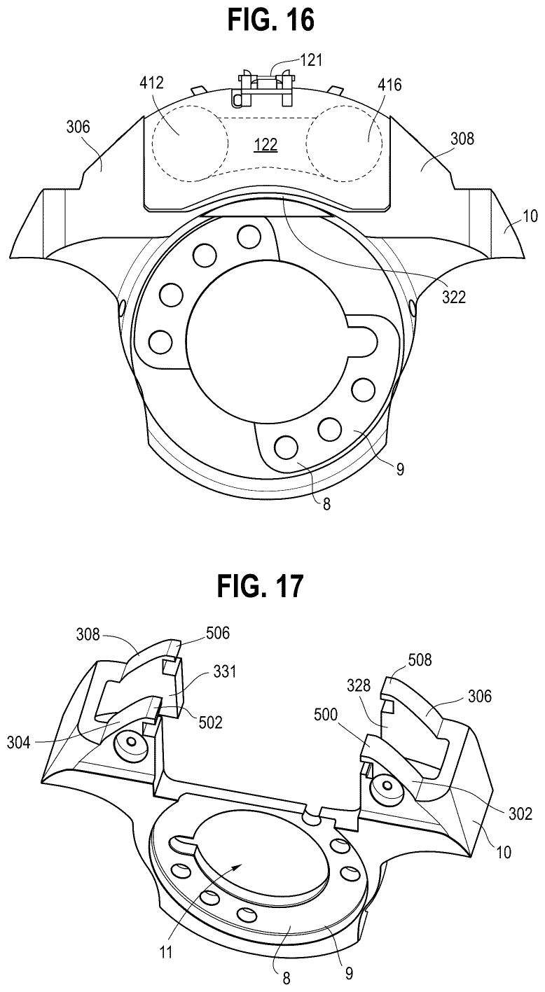

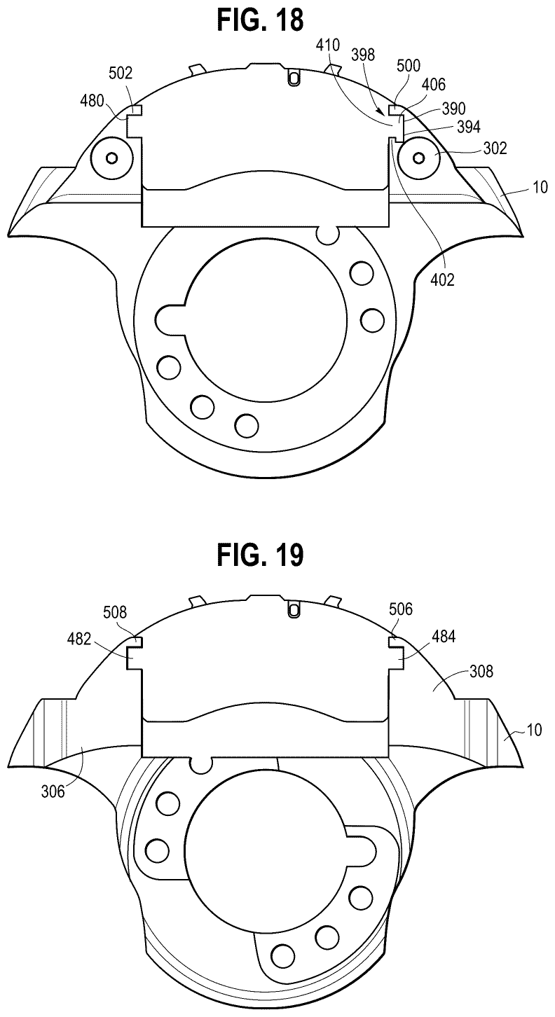

In essence, during braking, the friction on the brake pads 120, 122 applies a tension force to a leading end 410, 412 of at least one of the inboard and/or outboard brake pads in response to engaging the rotor 128 with the brake pads 120, 122. The tension force is absorbed with and by the carrier portion pad supports 302, 306 of the torque plate 8. At the same time, a compression force may be applied to the trailing end 414, 416 of the outboard brake pads in response to engaging the rotor surface with the brake pads 120, 122. The trailing end 414, 416 may be configured with tabs having an L-shape or hammer head shape, or may simply be a linear tab 480, 484 lacking any bearing surfaces extending in the Z direction and thereby being incapable of carrying any tension load during reverse direction braking as shown in FIGS. 18 and 19. In some embodiments, the abutting surfaces creating tension may be incorporated only on the inboard pad to accommodate specific design requirements. These may include brake system designs where a taper wear countermeasure feature is only necessary for the inboard pad, or to accommodate pad installation where the pads may be installed only in a radial direction. In some embodiments, shown in FIGS. 16 and 19, the outboard carrier portion support pads, or torque plate horns, and the leading ends 412 of the outboard brake pads 122 also may not be configured with any bearing surfaces to absorb a tension load. Rather, the brake pad is simply configured with a linear tab 482 that helps locate the brake pad in slot 483, as shown in FIG. 19, or is configured without any tabs as shown in FIG. 16.

Referring to FIGS. 11-13C and 17-19, various embodiments of the disc brake system include a capture system, wherein the interface between the tabs 406, 408, 480, 482, 484, 406 or end 354 are captured in an opening having an outer surface or wall 500, 502, 506, 508 such that the pads 120, 122 are not capable of moving in the Z direction relative to the carrier portion 10.

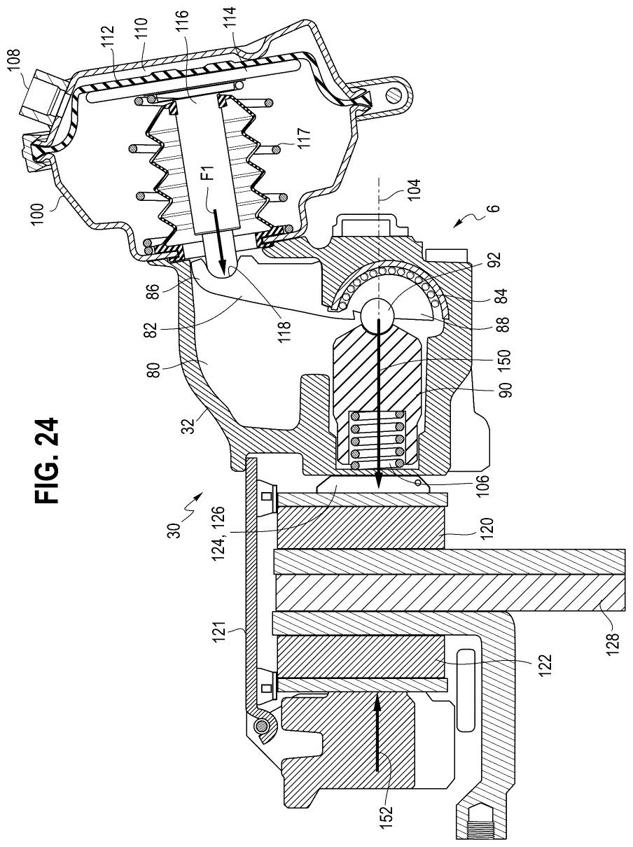

Referring to FIGS. 21 and 24, the disc brake system includes a pair of guide pins 16, 18 mounted to the carrier portion 10 with fasteners 20, 22, shown as bolts, and extend in the axial direction 2. In one embodiment, a long guide pin 16 has a tight clearance fit and is the primary load carrying pin whilst a second guide pin 18 has a greater clearance and is the secondary load carrying element. It should be understood that the torque plate with an integrated carrier portion provides for mounting the guide pins directly to the torque plate. In one embodiment, the guide pins 16, 18 are coupled to the torque plate by way of the fasteners 20, 22 through a threadable engagement with the housing or with nuts positioned on an opposite side of the housing, although the guide pins may be coupled by press fit, welding or other known fastening techniques. Each guide pin 16, 18 has an outer circumferential surface 24, 26. A caliper 30 includes a housing 32 having a pair of bores 34, 36 positioned to receive the guide pins 16, 18 respectively.

The caliper housing 32 defines a cavity 80. A lever 82 is disposed in the cavity and is supported by two eccentric bearings 84 disposed in the cavity. The lever 82 has a first portion 86, or arm, extending laterally into the cavity and a second portion 88 engaging a bridge 90, for example through a cylindrical bearing 92. The first portion 86 is engaged by an actuator 100, which may be mounted to the caliper housing 32 with fasteners 102. The bridge 90 is biased inwardly, away from the brake pads 120, 122 along a longitudinal axis 104 by a return spring 106.

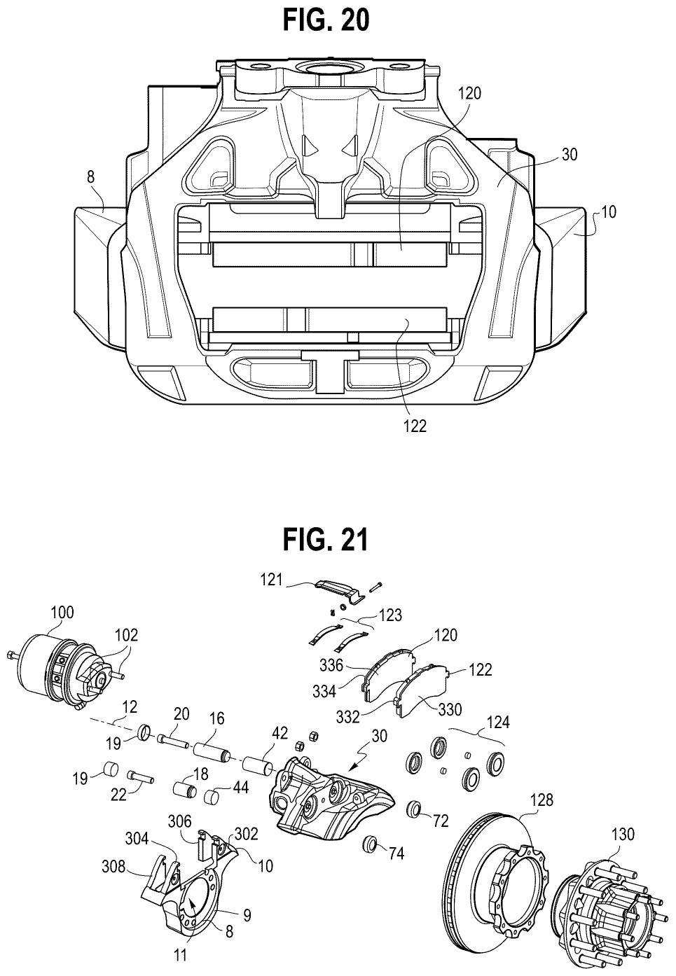

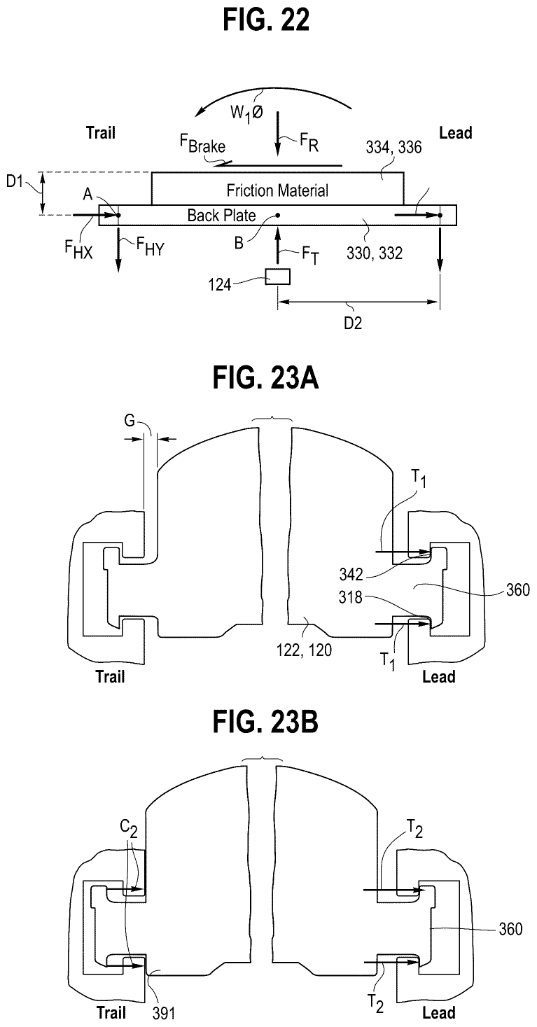

The actuator 100 includes an air supply port 108 in fluid communication with a service brake chamber 110. As air is introduced into the chamber during application of the vehicle brakes, the air applies pressure in the chamber and expands the diaphragm 112 which in turn applies a force to and moves a pressure plate 114 and pushrod 116 in an axial direction. The pushrod 116 includes a pusher tip 118 that engages the lever cup creating a ball joint, and pushes the lever 82. The lever 82 thereafter rotates and pivots about the eccentric bearing 84 from an unactuated home position to an actuated position where the clamping load equates to the actuator input force minus internal friction losses. As the lever 82 pivots, the second portion 88 of the lever engages and moves the bridge 90 outwardly in the axial direction from a first position to a second position against the force of the return spring 106. The bridge 90 is coupled to and moves a pair of tubes and tappets 124, 126 in the longitudinal direction 2 so as to move an inner brake pad 120 in the longitudinal direction. The inner brake pad 120 engages the brake rotor 128. Further movement of the bridge 90 forces the caliper 30, sliding on the guide pins 16, 18, away from the rotor 128 in the longitudinal direction 2 from a non-braking position to a braking position. The sliding movement of the caliper 30 on the guide pins 16, 18 moves the outer brake pad 122 inwardly toward an opposite side of the rotor 128, thereby clamping the rotor 128 between the inner and outer brake pads 120, 122 and applying a braking force to the brake rotor 128 and attached wheel 130. The brake pads 120, 122 are coupled to the carrier and caliper with a pad retainer 121 and springs 123. Alternatively, in those embodiments with a capture system, as shown in FIGS. 11- 13C and 17-19, the pad retainer 121 may be omitted as shown in FIG. 20.

When the vehicle brakes are released, the air pressure in the service brake chamber 110 is exhausted and the return springs 117, 106 in the chamber and in the cavity acting on the bridge 90 return the air disc brake to a neutral, non-braked position. To maintain an appropriate running clearance gap between the rotor 128, 428 and the brake pads 120, 122 over time, the non-braked position may be mechanically adjusted by a mechanism in the caliper. The adjustment mechanism operates automatically whenever the brakes are activated, to compensate for rotor and brake pad wear and to keep the running clearance constant.

In operation, the method of actuating the air disc brake system includes applying a force (F1) to the lever 82 with the actuator 100, moving the bridge 90 in a first axial direction 150 with the lever 82 in response to the force (F1) being applied to the lever, moving an inner brake pad 120 operably coupled to the bridge 90 in the first axial direction 150, sliding a caliper 30 in a second axial direction 152 opposite the first axial direction on the guide pin 16, elastically deforming the sealing ring 52 disposed between the caliper 30 and the guide pin 16, and moving the outer brake pad 122 in the second axial direction 152 with the caliper 30. The method may further include releasing the force from the lever 82, biasing the bridge 90 in the second axial 152 direction with a spring 106, and biasing the caliper 30 in the first axial direction 150 with the sealing ring 52.

Although the present invention has been described with reference to preferred embodiments, those skilled in the art will recognize that changes may be made in form and detail without departing from the spirit and scope of the invention. As such, it is intended that the foregoing detailed description be regarded as illustrative rather than limiting and that it is the appended claims, including all equivalents thereof, which are intended to define the scope of the invention.

What is claimed is:

1. A disc brake system comprising:
a torque plate comprising:
a mounting portion with an opening shaped to receive a vehicle axle; and
a carrier portion integrally formed with the mounting portion as a one- piece unit, wherein the carrier portion comprises an inboard leading pad support, an inboard trailing pad support, an outboard leading pad support, and an outboard trailing pad support, wherein the inboard leading and trailing pad supports are spaced apart and define an inboard pad receiving opening, and wherein the outboard leading and trailing pad supports are spaced apart and define an outboard pad receiving opening, wherein at least one of the inboard and/or outboard leading pad supports comprises a first bearing surface facing away from a corresponding one of the inboard and/or outboard receiving openings;
an inboard brake pad disposed in the inboard pad receiving opening; and
an outboard brake pad disposed in the outboard pad receiving opening;
wherein at least one of the inboard and/or outboard brake pads comprises a second bearing surface facing toward the first bearing surface and the corresponding one of the inboard and/or outboard receiving openings, wherein the first and second bearing surfaces are configured to engage when the disc brake system is actuated such that at least a portion of the at least one inboard and/or outboard brake pads is put in tension.

2. The disc brake system of claim 1 wherein the inboard leading and trailing pad supports are aligned with the mounting portion, and wherein the outboard leading and trailing pad portions are laterally spaced from the mounting portion.

3. The disc brake system of claim 2 wherein the torque plate comprises a beam extending between and connecting the outboard leading and trailing pad supports.

4. The disc brake system of claim 2 wherein the outboard leading and trailing pad supports are cantilevered.

5. The disc brake system of clam 4 wherein the outboard leading pad support comprises the first bearing surface, and wherein the outboard brake pad comprises the second bearing surface.

6. The disc brake system of claim 1 wherein at least one of the inboard and/or outboard leading pad supports comprises a pair of spaced apart first bearing surfaces facing away from the corresponding one of the inboard and/or outboard receiving openings, and wherein at least one of the inboard and/or outboard brake pads comprises a pair of spaced apart second bearing surfaces facing toward the first bearing surface and the corresponding one of the inboard and/or outboard receiving openings, wherein the pairs of first and second bearing surfaces are configured to engage when the disc brake system is actuated.

7. The disc brake system of claim 6 wherein the at least one of the inboard and/or outboard leading pad supports comprises a T-shaped opening defining the pair of spaced apart first bearing surfaces, and wherein at least one of the inboard and/or outboard brake pads comprises a hammerhead end portion defining the pair of spaced apart second bearing surfaces, wherein the hammerhead end portion is disposed in the T-shaped opening.

8. The disc brake system of claim 1 wherein each of the inboard and outboard leading pad supports comprises the first bearing surface, and wherein each of the inboard and outboard brake pads comprises the second bearing surface.

9. The disc brake system of claim 1 wherein each of the inboard leading pad support, the inboard trailing pad support, the outboard leading pad support, and the outboard trailing pad support comprises a slot, and wherein each of the inboard and outboard brake pads comprise opposite ends having tabs disposed in corresponding ones of the slots.

10. The disc brake system of claim 9 wherein at least some of the slots are T- shaped, and at least some of the tabs have a hammerhead shape.

11. The disc brake system of claim 1 wherein the inboard and outboard brake pads each comprise a backing plate and a friction material supported by the backing plate, wherein the first bearing surface is formed on the backing plate.

12. An torque plate for a disc brake system comprising:
a mounting portion with an opening shaped to receive a vehicle axle; and
a carrier portion integrally formed with the mounting portion as a one- piece unit, wherein the carrier portion comprises an inboard leading pad support, an inboard trailing pad support, an outboard leading pad support, and an outboard trailing pad support, wherein the inboard leading and trailing pad supports are spaced apart and define an inboard pad receiving opening, and wherein the outboard leading and trailing pad supports are spaced apart and define an outboard pad receiving opening;
wherein at least one of the inboard and/or outboard leading pad supports comprises a slot defining a bearing surface facing away from a corresponding one of the inboard and/or outboard receiving openings.

13. The torque plate of claim 12 further comprising a beam extending between and connecting the outboard leading and trailing pad supports.

14. The torque plate of claim 12 wherein the outboard leading and trailing pad supports are cantilevered.

15. The torque plate of clam 14 wherein the outboard leading pad support comprises the slot defining the bearing surface.

16. The torque plate of claim 12 wherein the slot comprises a T-shaped opening defining a pair of spaced apart bearing surfaces.

17. A method of actuating a disc brake system comprising:
engaging a rotor rotating about an axis with inboard and outboard brake pads;
applying a tension force to a leading end of at least one of the inboard and/or outboard brake pads in response to the engaging of the rotor; and
absorbing the tension force with a carrier portion of an torque plate, wherein the carrier portion is integrally formed with a mounting portion as a one-piece unit, wherein the mounting portion comprises an opening centered about the axis and shaped to receive a vehicle axle.

18. The method of claim 17 wherein the applying the tension force comprises engaging the leading end of the at least one inboard and/or outboard brake pads with a pad support defined by the carrier portion.

19. The method of claim 18 wherein the absorbing the tension force further comprises elastically bending the pad support.

20. The method of claim 19 further comprising applying a compression force to a trailing leading end of at least one of the inboard and/or outboard brake pads in response to the engaging of the rotor surface.
